(19) United States
(12) Patent Application Publication
(10) Pub. No.: US 2026/0220292 A1
(43) Pub. Date: Jul. 30, 2026

(54) DATA ASSET LIFECYCLE MANAGEMENT FOR DATA PLATFORMS

(71) Applicant: Target Brands, Inc., Minneapolis, MN (US)

(72) Inventor: Sravanthi Kondoju, Dallas, TX (US)

(21) Appl. No.: 19/578,007

(22) Filed: Mar. 25, 2026

(51) Int. Cl. G06F 21/62; G06F 11/30; G06F 11/32

(52) U.S. Cl. CPC G06F 21/6218; G06F 11/3082; G06F 11/328

(57) ABSTRACT

The disclosed system and method relates to managing data assets in a data storage environment by capturing telemetry associated with operations performed on the data assets, processing the telemetry to generate lifecycle intelligence, and evaluating the lifecycle intelligence to determine whether the data assets satisfy lifecycle governance conditions. The system and method may transform telemetry into lifecycle analytics describing activity associated with the data assets, correlate the lifecycle intelligence with metadata including ownership information, and determine whether the data assets satisfy lifecycle management criteria. Based on the evaluation, the system and method may initiate lifecycle governance actions including locking, notification, dashboard presentation, and controlled deletion workflows. In some examples, controlled deletion decisions may be based on historical usage information, ownership status, and organizational context to improve storage efficiency, reduce infrastructure impact associated with inactive data, and support automated or semi-automated governance of enterprise data assets.

### BACKGROUND

Enterprises increasingly rely on large-scale distributed storage platforms to manage growing volumes of data generated by analytics, machine learning, and operational workloads. These environments often store vast numbers of files and datasets across clusters of computing resources, enabling scalable access and processing of data assets by numerous users and applications. As data volumes and usage patterns continue to expand and evolve, organizations employ various tools and practices to monitor storage utilization, track data access activity, and support governance of data assets within these distributed systems.

### SUMMARY

Generally, the present disclosure relates to a system and method for managing data assets within distributed storage environments based on analysis of storage access activity and associated metadata.

In one embodiment, a system for managing data assets stored within a data storage environment is disclosed. The system comprises: one or more processors; and a memory storing instructions that, when executed by the one or more processors, cause the system to: capture telemetry associated with operations performed on one or more data assets stored within the data storage environment; process the telemetry to generate lifecycle intelligence associated with the one or more data assets by transforming the telemetry into lifecycle analytics describing activity associated with the one or more data assets; evaluate the lifecycle intelligence to determine whether the one or more data assets satisfy one or more lifecycle governance conditions; and initiate, based on the evaluation of the lifecycle intelligence, one or more lifecycle governance actions associated with the one or more data assets, the lifecycle governance actions including executing a controlled deletion workflow to remove at least a portion of the one or more data assets from the data storage environment.

In another embodiment, a computer-implemented method for managing data assets stored within a data storage environment is disclosed. The method comprises: capturing, by a computing system, telemetry associated with operations performed on one or more data assets stored within the data storage environment; processing the telemetry to generate lifecycle intelligence associated with the one or more data assets by transforming the telemetry into lifecycle analytics describing activity associated with the one or more data assets; evaluating the lifecycle intelligence to determine whether the one or more data assets satisfy one or more lifecycle governance conditions; and initiating, based on the evaluation of the lifecycle intelligence, one or more lifecycle governance actions associated with the one or more data assets, the lifecycle governance actions including executing a controlled deletion workflow to remove at least a portion of the one or more data assets from the data storage environment.

In yet another embodiment, a system for managing data assets stored within a data storage environment is disclosed. The system comprises: one or more processors; and a memory storing instructions that, when executed by the one or more processors, cause the system to: capture telemetry associated with operations performed on one or more data assets stored within the data storage environment; retrieve metadata associated with the one or more data assets; process the telemetry and the metadata to generate lifecycle intelligence associated with the one or more data assets, the lifecycle intelligence including historical usage information derived from the telemetry; determine, based on the metadata, an ownership status associated with the one or more data assets; evaluate the lifecycle intelligence, including historical usage information derived from the telemetry, in combination with the ownership status to determine whether at least a portion of the one or more data assets satisfies one or more lifecycle governance conditions; and execute a controlled deletion workflow to remove the at least the portion of the one or more data assets from the data storage environment in response to determining that the one or more lifecycle governance conditions are satisfied, the lifecycle governance conditions being based on the combination of the historical usage information and the ownership status.

This summary is provided to introduce a selection of concepts in a simplified form that are further described below in the Detailed Description. This summary is not intended to identify key features or essential features of the claimed subject matter, nor is it intended to be used to limit the scope of the claimed subject matter.

### BRIEF DESCRIPTION OF THE DRAWINGS

The following drawings are illustrative of particular embodiments of the present disclosure and therefore do not limit the scope of the present disclosure. The drawings are not to scale and are intended for use in conjunction with the explanations in the following detailed description. Embodiments of the present disclosure will hereinafter be described in conjunction with the appended drawings, wherein like numerals denote like elements.

FIG. 1 illustrates an example configuration of a data asset lifecycle management (DALM) system.

FIG. 2 illustrates an example configuration of the data asset lifecycle management platform of FIG. 1.

FIG. 3 illustrates an example configuration of the audit data processing engine of the data asset lifecycle management platform of FIG. 1.

FIG. 4 illustrates an example configuration of the governance and insight engine of the data asset lifecycle management platform of FIG. 1.

FIG. 5 illustrates an example dashboard representing missing usage related data as generated by the data asset lifecycle management platform of FIG. 1.

FIG. 6 illustrates an example lifecycle insight dashboard representing inactive ownership related data generated by the data asset lifecycle management platform of FIG. 1.

FIG. 7 illustrates an example method performed by the data asset lifecycle management platform of FIG. 1.

FIG. 8 illustrates an example block diagram of a virtual or physical computing system 800 used to implement the systems, platforms, and processes described herein.

### DETAILED DESCRIPTION

Various embodiments will be described in detail with reference to the drawings, wherein like reference numerals represent like parts and assemblies throughout the several views. Reference to various embodiments does not limit the scope of the claims attached hereto. Additionally, any examples set forth in this specification are not intended to be limiting and merely set forth some of the many possible embodiments for the appended claims.

The present disclosure relates to systems and methods for managing data asset lifecycles within distributed storage environments based on analysis of storage access activity and contextual metadata. Large-scale enterprise data platforms may rely on distributed file systems, such as Hadoop Distributed File System (HDFS), to support analytics, data science, and machine learning workloads that generate rapidly increasing volumes of data. As organizations scale these workloads, storage platforms may accumulate hundreds of millions or even billions of files across distributed clusters, resulting in persistent growth in both file counts and storage consumption. A significant portion of stored data may become inactive, abandoned, or owned by users who no longer maintain responsibility for the datasets, such as employees who have transferred teams or left the organization. Conventional storage management approaches may rely on quota enforcement, manual audits, or coarse lifecycle rules such as deleting files older than a predefined age threshold or migrating older data to lower-cost storage tiers. Such approaches may fail to account for actual data usage patterns, ownership context, and organizational structure. Additionally, conventional enterprise tools may either expose low-level audit logs that are impractical to analyze at scale or provide high-level dashboards that lack integration with governance enforcement mechanisms. As a result, platform administrators may conduct reactive and manual cleanup campaigns that introduce operational risk and disruption while failing to address underlying causes of uncontrolled data growth.

In one example, a data asset lifecycle management platform may provide an integrated system that continuously monitors, analyzes, and governs data assets stored in distributed storage environments. The data asset lifecycle management platform may transform raw file-system audit events into lifecycle intelligence that may support automated or semi-automated governance decisions. The data asset lifecycle management platform may ingest storage access events, normalize and aggregate the events into usage-centric metrics, and correlate usage metrics with ownership and organizational metadata. In one example, the data asset lifecycle management platform may identify inactive datasets, orphaned assets associated with inactive users, and other candidate data assets that may satisfy lifecycle management criteria. Unlike static lifecycle tools that may rely on simple age or size thresholds, the data asset lifecycle management platform may evaluate retention and cleanup decisions based on actual historical access activity, ownership status, and organizational context.

The data asset lifecycle management platform may operate as a multi-layer technical pipeline that processes audit telemetry generated by a distributed storage system. The data asset lifecycle management platform may include an audit event ingestion engine configured to capture file-system audit events generated by a distributed storage platform, such as events indicating file creation, read operations, write operations, directory listing operations, or deletion events. Each audit event may include metadata such as user identity, file path, timestamp, and source host information. An event streaming engine may transport the captured audit events through a distributed event stream that supports reliable and ordered ingestion of storage activity across the cluster. The captured audit events may be persisted within an audit event repository that enables reuseable storage and fault-tolerant processing of audit telemetry at enterprise scale.

In one example, an audit data processing engine may process persisted audit events to generate structured lifecycle intelligence. The audit data processing engine may perform operations including parsing log fields into structured schemas, filtering system-level or non-actionable events, normalizing file paths and user identifiers, and deriving attributes such as dataset identifiers or file-versus-directory classification. The audit data processing engine may aggregate audit events into usage metrics such as access frequency, last-access timestamps, and rolling usage windows over configurable time intervals. The resulting usage datasets may be stored within a lifecycle analytics repository in an analytics-optimized format that supports high-performance queries across billions of records. A metadata correlation engine may correlate usage datasets with external metadata sources, including file-system inventory snapshots, user identity systems, and employment status records. For example, the metadata correlation engine may identify datasets owned by terminated users, determine directories containing large volumes of inactive files, or detect datasets that have not been accessed within configurable time thresholds.

In one example, a governance and insight engine may expose lifecycle intelligence through interactive dashboards that present aggregated metrics across organizational units, asset owners, file types, and usage categories. For example, the governance and insight engine may present dashboards identifying directories containing unused files, datasets associated with inactive owners, or storage consumption attributable to replicated datasets within distributed storage clusters. The governance and insight engine may further integrate with access control or policy enforcement systems to initiate lifecycle governance actions. In one example, the governance and insight engine may initiate workflows that lock inactive datasets, notify responsible owners, quarantine data assets, or schedule deletion following configurable observation periods. For example, a dataset that has not been accessed for ninety days and is owned by a terminated employee may be automatically identified and locked to prevent modification prior to a controlled deletion workflow.

The systems and methods described herein may provide significant technical advantages relative to conventional storage management approaches. By continuously capturing complete storage access histories and transforming audit telemetry into actionable lifecycle intelligence, the data asset lifecycle management platform may enable organizations to govern data assets at enterprise scale while reducing operational risk associated with manual cleanup campaigns. The correlation of usage activity with ownership and organizational metadata may allow the system to identify orphaned or high-risk datasets that conventional tools may overlook. Furthermore, the integration of lifecycle analytics with enforcement mechanisms may create a closed-loop governance workflow that may safely automate storage cleanup decisions while preserving administrator oversight through configurable approval and observation mechanisms. As a result, the systems and methods described herein may provide a practical technological solution that improves distributed storage efficiency, reduces infrastructure costs associated with replicated inactive data, and enhances reliability of large-scale data platforms.

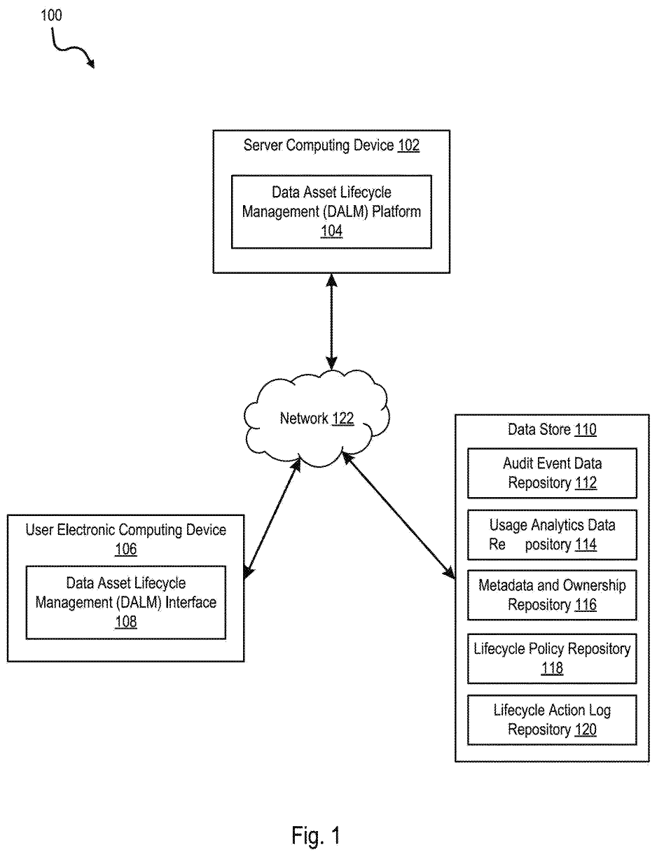

FIG. 1 illustrates an example configuration of a data asset lifecycle management (DALM) system 100. The DALM system 100 may be configured to monitor, analyze, and govern data assets stored within a distributed storage environment by converting file-system access events into lifecycle intelligence that may support governance and cleanup decisions. In one example, the DALM system 100 may include a server computing device 102 hosting a data asset lifecycle management (DALM) platform 104, a user electronic computing device 106 including a data asset lifecycle management (DALM) interface 108, and a data store 110, wherein the components may be communicatively connected to each other through a network 122. Although the example illustrated in FIG. 1 depicts a particular arrangement of components, the DALM system 100 may be implemented using more or fewer components depending on the implementation environment.

In some examples, the server computing device 102 may include one or more computing systems configured to execute the DALM platform 104. The server computing device 102 may be implemented as a cloud computing environment, a server cluster, a server farm, or other distributed computing infrastructure capable of processing large volumes of storage telemetry data. In one example, the DALM platform 104 may monitor file activity generated by a distributed storage platform, such as a Hadoop Distributed File System (HDFS) cluster storing enterprise analytics datasets. For example, the distributed storage platform may host datasets used by data science teams, machine learning workloads, or analytics pipelines, and the DALM platform 104 may analyze usage patterns associated with those datasets to identify inactive or orphaned assets that may satisfy lifecycle management criteria.

In some examples, the user electronic computing device 106 may include an electronic computing device operated by an administrator, platform engineer, or data owner responsible for managing enterprise data assets. The user electronic computing device 106 may include the DALM interface 108 that may be displayed on a display screen associated with the user electronic computing device 106. The DALM interface 108 may allow a user to access the DALM platform 104 through the network 122 to review lifecycle analytics, investigate storage usage patterns, and initiate governance workflows. In one example, the DALM interface 108 may present dashboards that summarize metrics associated with inactive datasets, storage consumption attributable to unused files, or datasets owned by inactive users. For example, a platform administrator may use the DALM interface 108 to identify directories containing large volumes of datasets that have not been accessed within a defined time window.

In some examples, the data store 110 may include one or more electronic databases configured to store data generated and used by the DALM system 100. The data store 110 may include an audit event data repository 112, a usage analytics data repository 114, a metadata and ownership repository 116, a lifecycle policy repository 118, and a lifecycle action log repository 120. The audit event data repository 112 may store captured file-system audit events that describe storage access activity, including operations such as file creation, file reads, file writes, directory listing operations, or file deletion events. The usage analytics data repository 114 may store processed lifecycle intelligence derived from the audit events, such as aggregated usage metrics including last-access timestamps, access frequency, and inactivity indicators associated with data assets. The metadata and ownership repository 116 may store contextual metadata associated with data assets, such as file-system inventory snapshots, dataset ownership records, organizational hierarchy information, and user identity data that may allow the DALM platform 104 to determine ownership context associated with stored data assets.

In some examples, the lifecycle policy repository 118 may store lifecycle governance policies that may define conditions under which data assets may be flagged for cleanup or governance actions. For example, the lifecycle policy repository 118 may include policies indicating that a dataset that has not been accessed for a defined time interval and is associated with an inactive user account may be designated as a candidate asset for lifecycle management. The lifecycle action log repository 120 may store records of lifecycle actions initiated by the DALM platform 104, such as notifications sent to dataset owners, data locking events, quarantine operations, or controlled deletion workflows. In one example, the lifecycle action log repository 120 may maintain an audit trail of governance operations performed by the DALM platform 104 to ensure transparency and operational safety.

The network 122 may include one or more communication networks configured to enable communication between the server computing device 102, the user electronic computing device 106, and the data store 110. In one example, the network 122 may include a local area network, a wide area network, the Internet, or a combination of communication networks. Through the network 122, the user operating the user electronic computing device 106 may access the DALM platform 104 executing on the server computing device 102 to review lifecycle insights and initiate governance workflows associated with data assets stored within an enterprise distributed storage environment.

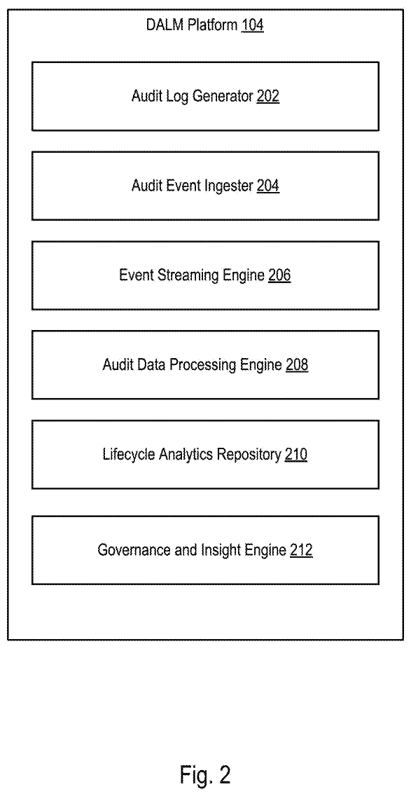

FIG. 2 illustrates an example configuration of the DALM platform 104 and several functional components that may operate together to generate lifecycle intelligence associated with data assets stored within a distributed storage environment. In one example, the DALM platform 104 may be configured to continuously capture storage access activity, transform the captured activity into structured usage intelligence, correlate the usage intelligence with ownership and organizational metadata, and initiate governance workflows associated with inactive or orphaned data assets. The DALM platform 104 may therefore operate as an end-to-end lifecycle intelligence pipeline that converts low-level storage audit telemetry into actionable lifecycle governance decisions. As illustrated in FIG. 2, the DALM platform 104 may include an audit log generator 202, an audit event ingester 204, an event streaming engine 206, an audit data processing engine 208, a lifecycle analytics repository 210, and a governance and insight engine 212. Although the components illustrated in FIG. 2 depict a particular configuration, the DALM platform 104 may be implemented using additional components, fewer components, or alternative arrangements depending on the architecture of the underlying enterprise data platform.

In one example, the audit log generator 202 may be configured to generate audit records associated with file-system activity occurring within a distributed storage platform. The audit log generator 202 may operate within or alongside a distributed file system environment, such as a HDFS cluster, object storage platform, or enterprise data lake environment. The audit log generator 202 may record storage access events describing operations performed on data assets stored within the distributed storage system. For example, the audit log generator 202 may generate audit entries corresponding to operations such as file creation events, read operations, write operations, directory listing operations, or file deletion operations. Each audit record may include contextual metadata such as a file path identifying a dataset location, a user identifier associated with a requesting user, a timestamp identifying when the operation occurred, a source host identifier, and an operation type describing the requested action.

For example, a data science user executing a machine learning training job may access a dataset stored within a directory path such as “/analytics/customer-model/training-data. csv,” and the audit log generator 202 may generate a corresponding audit entry recording that the dataset was accessed by a particular user account at a specific time. In some implementations, the audit log generator 202 may capture audit events directly from storage platform audit logs generated by components such as HDFS NameNodes. In other implementations, the audit log generator 202 may capture access telemetry generated by object storage services, distributed databases, or cloud-based storage systems.

In one example, the audit event ingester 204 may be configured to collect audit events generated by the audit log generator 202 and transmit the events into the lifecycle intelligence processing pipeline implemented by the DALM platform 104. The audit event ingester 204 may monitor audit log streams generated by the distributed storage environment and convert the raw audit entries into structured event records suitable for downstream processing. For example, the audit event ingester 204 may detect newly generated audit entries within storage platform log files and convert those entries into event messages that include standardized fields such as file path, operation type, user identity, timestamp, and source system information. The audit event ingester 204 may further ensure reliable delivery of the captured audit events by implementing message acknowledgment or retry mechanisms that may prevent event loss during transmission.

In one example, the audit event ingester 204 may publish the captured events into an event distribution infrastructure implemented by the event streaming engine 206. In some implementations, the audit event ingester 204 may be implemented as a lightweight monitoring service executing on cluster nodes within the distributed storage platform. In other implementations, the audit event ingester 204 may operate as an external telemetry collector that consumes audit log feeds exported by the distributed storage environment.

The event streaming engine 206 may be configured to transport, buffer, and distribute captured audit events across the processing pipeline of the DALM platform 104. In one example, the event streaming engine 206 may operate as a distributed commit log or event bus capable of supporting high-throughput ingestion of storage telemetry generated across large enterprise storage clusters. The event streaming engine 206 may therefore provide durability, ordering, and replay capability for captured audit events. For example, the event streaming engine 206 may store the event messages received from the audit event ingester 204 within an ordered event log that may allow downstream processing components to consume the events asynchronously. The replay capability of the event streaming engine 206 may allow the DALM platform 104 to reprocess historical audit telemetry if processing failures occur or if additional analytics logic is introduced. In some implementations, the event streaming engine 206 may be implemented using distributed event streaming platforms such as Apache Kafka or equivalent message queue infrastructures. In other implementations, the event streaming engine 206 may be implemented using alternative distributed messaging technologies that support scalable ingestion of telemetry events.

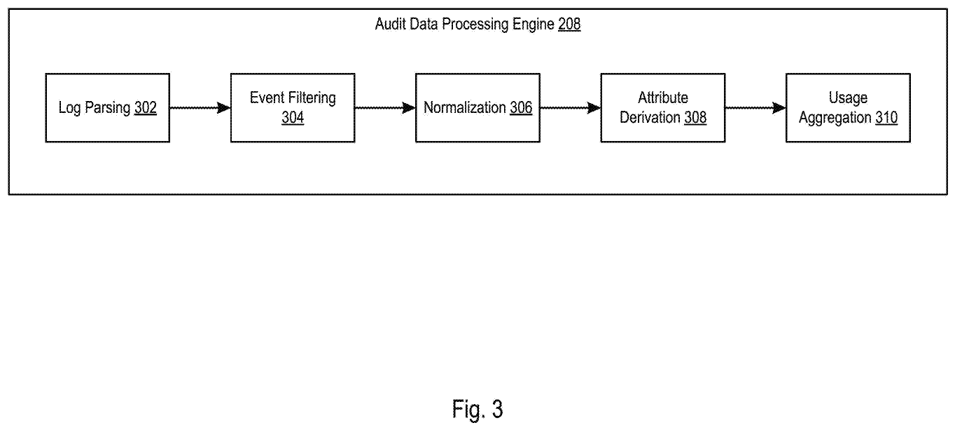

The audit data processing engine 208 may be configured to transform raw audit telemetry into structured usage intelligence that may support lifecycle analytics and governance decisions. The audit data processing engine 208 may consume event streams provided by the event streaming engine 206 and perform a sequence of transformation operations that convert semi-structured audit records into analytics-ready datasets. For example, the audit data processing engine 208 may parse raw audit log entries into structured schemas, filter out non-actionable system-level events, normalize file paths and user identifiers, derive additional attributes associated with the accessed data assets, and aggregate the events into usage-centric lifecycle metrics. In one example, the audit data processing engine 208 may generate metrics describing when a dataset was last accessed, how frequently a dataset has been accessed within a rolling time window, or whether a dataset has experienced any read activity within a defined period of time. The resulting usage intelligence may be stored within the usage analytics data repository 114 of the data store 110 for subsequent lifecycle analysis. In one example, the audit data processing engine 208 may further store the original captured audit records within the audit event data repository 112 to enable replayable processing and long-term telemetry retention. Additional implementation details associated with the audit data processing engine 208 are described in further detail in relation to FIG. 3.

In one example, the lifecycle analytics repository 210 may store structured lifecycle intelligence generated by the audit data processing engine 208. The lifecycle analytics repository 210 may therefore maintain analytics-ready datasets that describe usage patterns associated with data assets stored in the distributed storage environment. For example, the lifecycle analytics repository 210 may maintain records describing dataset access frequency, inactivity windows, replicated file sizes, ownership attributes, and other lifecycle indicators derived from the captured audit telemetry.

In one example, the lifecycle analytics repository 210 may store usage datasets within the usage analytics data repository 114 of the data store 110. The lifecycle analytics repository 210 may further retrieve ownership metadata and organizational context from the metadata and ownership repository 116 to enrich lifecycle analytics records with additional contextual attributes. For example, the lifecycle analytics repository 210 may correlate dataset usage metrics with employee identity systems in order to determine whether a dataset owner is associated with an inactive user account or a terminated employee.

The lifecycle analytics repository 210 may also incorporate storage system characteristics such as file replication factors used by distributed storage platforms. In distributed file systems such as HDFS, each file may be replicated across multiple storage nodes to ensure reliability, which may cause inactive datasets to consume multiple times the raw storage capacity. By incorporating replication metadata into lifecycle analytics records, the lifecycle analytics repository 210 may enable the DALM platform 104 to estimate the true infrastructure impact of inactive data assets.

The governance and insight engine 212 may be configured to analyze lifecycle intelligence generated by the DALM platform 104 and translate the intelligence into actionable governance workflows. In one example, the governance and insight engine 212 may retrieve lifecycle analytics datasets from the lifecycle analytics repository 210 and evaluate the datasets against governance policies stored within the lifecycle policy repository 118 of the data store 110. The governance and insight engine 212 may therefore determine whether particular datasets satisfy lifecycle management criteria based on a combination of usage history, ownership status, and organizational context.

For example, the governance and insight engine 212 may identify a dataset that has not been accessed for ninety days and is owned by a user account associated with a terminated employee. The governance and insight engine 212 may then determine that the dataset qualifies as an orphaned data asset and may initiate governance actions such as notifying responsible administrators, temporarily locking the dataset, or scheduling the dataset for deletion after a defined observation period. Unlike conventional lifecycle management systems that rely solely on static rules such as file age or file size thresholds, the governance and insight engine 212 may evaluate lifecycle conditions using historical usage activity derived from audit telemetry, ownership validation, and organizational metadata context.

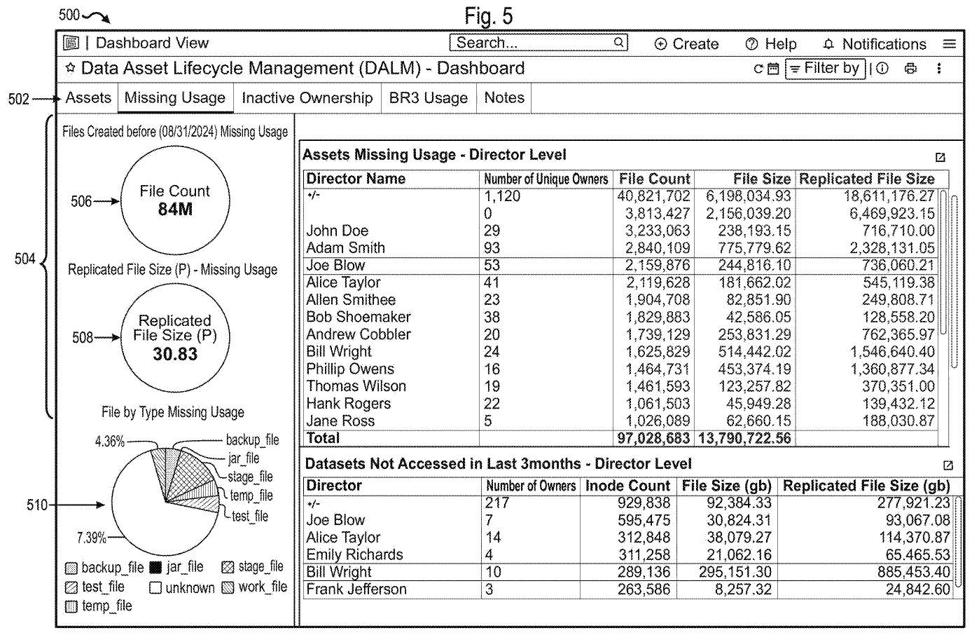

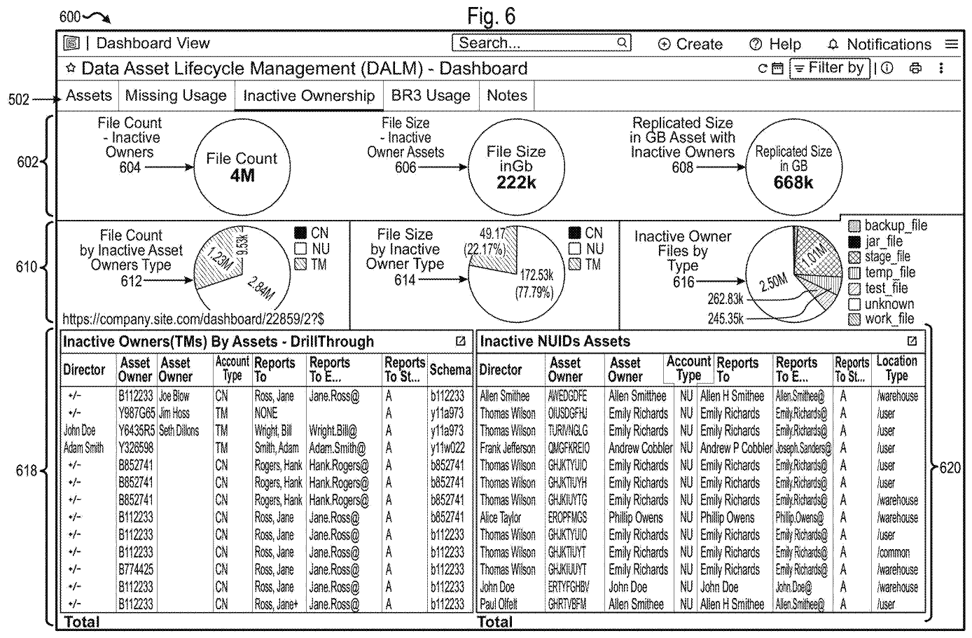

In one example, the governance and insight engine 212 may further generate lifecycle insights that may be presented through the DALM interface 108 executing on the user electronic computing device 106. For example, the governance and insight engine 212 may generate dashboard visualizations summarizing inactive data assets, directories containing large volumes of unused files, datasets owned by inactive users, or storage consumption attributable to replicated datasets. Such lifecycle insights may assist administrators in prioritizing cleanup actions and evaluating the operational impact of inactive data assets. Example dashboard visualizations generated by the governance and insight engine 212 are illustrated in FIG. 5 and FIG. 6.

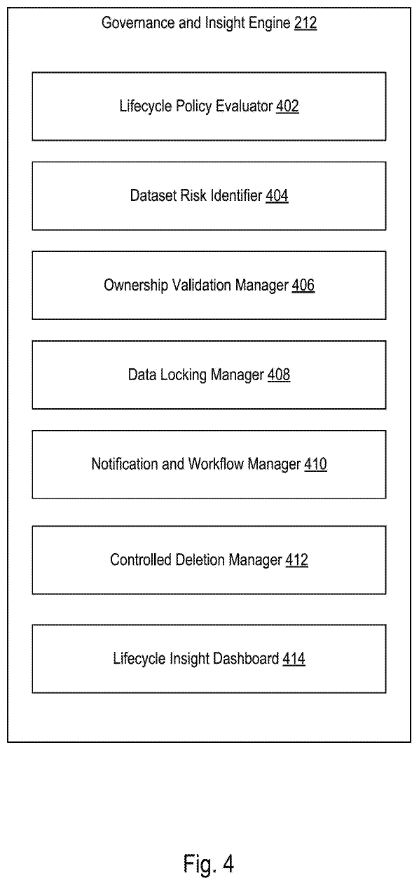

In some implementations, the governance and insight engine 212 may also record lifecycle governance actions within the lifecycle action log repository 120 of the data store 110 to maintain an audit trail associated with lifecycle enforcement activities. For example, the lifecycle action log repository 120 may store records describing dataset lock operations, administrator notifications, quarantine actions, or controlled deletion workflows initiated by the governance and insight engine 212. Additional implementation details associated with the governance and insight engine 212 are described in further detail in relation to FIG. 4.

FIG. 3 illustrates an example configuration of the audit data processing engine 208 of the DALM platform 104. The example configuration from FIG. 3 illustrates several processing stages that may be used to convert raw audit telemetry into structured lifecycle intelligence. In one example, the audit data processing engine 208 may be configured to process audit events received from the event streaming engine 206 and transform the events into structured usage datasets suitable for lifecycle analytics. As illustrated in FIG. 3, the audit data processing engine 208 may perform a sequence of processing operations including log parsing 302, event filtering 304, normalization 306, attribute derivation 308, and usage aggregation 310. The processing stages illustrated in FIG. 3 may operate sequentially, wherein each stage may transform the audit data received from the previous stage to progressively generate structured lifecycle intelligence. Although the illustrated stages are shown in a particular order, in other examples, the audit data processing engine 208 may implement the stages in alternative orders or may combine multiple stages depending on implementation requirements.

In one example, the log parsing stage 302 may be configured to convert raw audit records generated by the audit log generator 202 into structured event records that may be processed by downstream analytics components. The audit data processing engine 208 may receive audit events from the event streaming engine 206 that originate from file-system audit logs associated with a distributed storage environment.

For example, an audit record generated by a distributed file system may appear in an unstructured log format such as: “2025-03-18T10:14:22 user=jsmith operation=READ path=/analytics/customer-model/training-data.csv host=node12 replication=3”. The log parsing stage 302 may extract structured fields from the raw audit record including a timestamp field, a user identifier field, an operation type field, a file path field, and infrastructure attributes such as a source host identifier or replication factor associated with the dataset. The log parsing stage 302 may therefore transform the unstructured log entry into a structured event record such as:
{timestamp: 2025-03-18T10:14:22, user: jsmith, operation: READ, file_path:/analytics/customer-model/training-data.csv, host: node12, replication_factor: 3}.

In one example, the parsed audit records may be stored within the audit event data repository 112 of the data store 110 to maintain a persistent record of raw storage access activity. Persisting parsed audit records may allow the DALM platform 104 to replay historical audit events if additional analytics processing is required.

In an example, the event filtering stage 304 may be configured to remove non-actionable or system-generated audit events that may not represent meaningful data asset usage. Distributed storage platforms may generate a large volume of background operations that do not reflect actual user interaction with stored datasets. For example, system services may periodically perform metadata scans, automated replication checks, or health monitoring operations that may generate audit entries without representing real dataset consumption. The event filtering stage 304 may therefore examine parsed event records and remove entries associated with system-level operations, automated maintenance processes, or temporary system accounts. For example, if a parsed audit record indicates that a background system account accessed a file during a routine storage replication check, the event filtering stage 304 may discard the event. In contrast, if the parsed audit record indicates that a data scientist accessed a dataset during a machine learning training job, the event filtering stage 304 may retain the event for further processing.

In one example, the normalization stage 306 may be configured to standardize the structure and representation of event attributes so that downstream analytics components may evaluate usage activity consistently across large enterprise storage environments. For example, distributed storage environments may store data assets across multiple directory structures or platform namespaces that may represent the same logical dataset using slightly different file paths. The normalization stage 306 may standardize file path representations, user identifiers, and operation categories so that related audit events may be grouped together for lifecycle analysis. For example, file paths such as “/analytics/customer-model/ . . . /customer-model/training-data.csv” and “/analytics/customer-model/training-data.csv” may be normalized to a single canonical dataset path. Similarly, user identifiers originating from multiple identity systems may be standardized to a single enterprise identity identifier. The normalization stage 306 may also retrieve ownership or organizational metadata from the metadata and ownership repository 116 of the data store 110 in order to map user identifiers to associated departments, teams, or employment status information.

In one example, the attribute derivation stage 308 may generate additional lifecycle attributes associated with the processed audit events. The attribute derivation stage 308 may enrich normalized audit records with derived metadata fields that may facilitate lifecycle analytics. For example, the attribute derivation stage 308 may determine whether the accessed data asset represents a file or directory, identify a dataset grouping associated with a directory hierarchy, determine replication impact associated with the dataset, or identify whether the dataset owner is associated with an active or inactive user account.

In one example, the attribute derivation stage 308 may retrieve ownership metadata from the metadata and ownership repository 116 to determine whether a dataset owner corresponds to an employee who has left the organization. The attribute derivation stage 308 may therefore produce enriched event records such as: {dataset_id: customer-model-training-data, owner: jsmith, owner_status: inactive, operation: READ, timestamp: 2025-03-18T10: 14:22, replication_factor: 3}. The derived replication attribute may be particularly useful in distributed storage environments where files may be replicated across multiple storage nodes. For example, a dataset occupying 10 GB of logical storage space with a replication factor of three may consume approximately 30 GB of actual storage capacity. The attribute derivation stage 308 may therefore calculate derived metrics describing the replicated storage footprint associated with inactive datasets.

In one example, the usage aggregation stage 310 may be configured to aggregate processed event records into lifecycle usage metrics that describe how frequently datasets are accessed over time. Rather than analyzing individual audit events independently, the usage aggregation stage 310 may group event records by dataset identifier, directory path, or organizational owner in order to generate lifecycle metrics.

For example, the usage aggregation stage 310 may calculate metrics such as last-access timestamps, access frequency within rolling time windows, total file counts associated with a dataset directory, or replicated storage footprint associated with inactive assets. An example may involve the following aggregated lifecycle record produced by the usage aggregation stage 310: {dataset: customer-model-training-data, owner: jsmith, owner_status: inactive, last_access: 2024-12-10, access_count_90_days: 0, logical_size: 10 GB, replicated_size: 30 GB}. The aggregated lifecycle metrics may be stored within the usage analytics data repository 114 of the data store 110 so that the governance and insight engine 212 may analyze the metrics when evaluating lifecycle policies stored in the lifecycle policy repository 118.

The lifecycle metrics generated by the usage aggregation stage 310 may be accessed by the governance and insight engine 212 to determine whether particular datasets satisfy lifecycle management conditions. For example, the governance and insight engine 212 may evaluate aggregated lifecycle metrics and determine that a dataset has not been accessed within a defined time window and is associated with an inactive user account. The governance and insight engine 212 may therefore identify the dataset as a candidate asset for lifecycle governance. As described in relation to FIG. 4, the governance and insight engine 212 may subsequently initiate governance workflows including dataset locking, administrator notifications, or controlled deletion actions. Additionally, lifecycle metrics generated by the usage aggregation stage 310 may be used to generate lifecycle dashboards presented through the DALM interface 108, examples of which are illustrated in FIG. 5 and FIG. 6.

FIG. 4 illustrates an example configuration of the governance and insight engine 212 of the DALM platform 104. The example configuration illustrates several components that may be used to translate lifecycle analytics into actionable governance workflows. The governance and insight engine 212 may be configured to analyze lifecycle intelligence generated by the audit data processing engine 208 and stored within the lifecycle analytics repository 210, evaluate the lifecycle intelligence against governance policies, and initiate lifecycle management actions associated with data assets stored within a distributed storage environment. In one example, the governance and insight engine 212 may determine whether particular datasets are inactive, orphaned, or associated with elevated infrastructure impact based on factors such as historical usage activity, ownership status, organizational context, and replicated storage footprint.

As illustrated in FIG. 4, the governance and insight engine 212 may include a lifecycle policy evaluator 402, a dataset risk identifier 404, an ownership validation manager 406, a data locking manager 408, a notification and workflow manager 410, a controlled deletion manager 412, and a lifecycle insight dashboard 414. Although these components are illustrated in a particular arrangement, the governance and insight engine 212 may be implemented using additional or alternative components depending on the governance architecture implemented within the enterprise environment.

The lifecycle policy evaluator 402 may be configured to evaluate lifecycle analytics records against lifecycle management policies stored within the lifecycle policy repository 118 of the data store 110. The lifecycle policy evaluator 402 may retrieve aggregated usage metrics from the usage analytics data repository 114 and determine whether the metrics satisfy lifecycle conditions defined by enterprise governance policies. For example, a lifecycle policy stored within the lifecycle policy repository 118 may specify that datasets that have not been accessed within a ninety-day time window and are owned by inactive users should be flagged as candidate assets for lifecycle management. In one example, the lifecycle policy evaluator 402 may analyze lifecycle metrics generated by the usage aggregation stage 310 described in FIG. 3 and determine that a dataset has not been accessed since a particular date. Unlike conventional lifecycle systems that may rely solely on file age or file size thresholds, the lifecycle policy evaluator 402 may evaluate policies using actual historical access activity derived from the audit event data repository 112 and the usage analytics data repository 114.

The dataset risk identifier 404 may analyze lifecycle analytics records to determine the operational impact associated with inactive or underutilized datasets. In some cases, a dataset may appear relatively small when measured by logical file size but may occupy significantly larger infrastructure capacity due to storage replication within the distributed storage environment. The dataset risk identifier 404 may therefore analyze replication attributes derived by the attribute derivation stage 308 described in FIG. 3 to determine the replicated storage footprint associated with each dataset.

For example, a dataset occupying 20 GB of logical storage may consume approximately 60 GB of infrastructure storage if the dataset is replicated across three storage nodes. The dataset risk identifier 404 may therefore calculate impact scores associated with inactive datasets by combining usage inactivity metrics from the usage analytics data repository 114 with replication metadata and storage capacity metrics. The dataset risk identifier 404 may thereby allow the DALM platform 104 to prioritize cleanup actions for datasets that impose the greatest infrastructure burden.

The ownership validation manager 406 may be configured to validate ownership context associated with datasets identified by the lifecycle policy evaluator 402 and the dataset risk identifier 404. Ownership validation may be important because lifecycle governance actions may require confirmation that a dataset owner is no longer responsible for maintaining the dataset or that the dataset is no longer actively used by an organizational team.

The ownership validation manager 406 may retrieve identity and employment metadata from the metadata and ownership repository 116 of the data store 110 in order to determine whether the dataset owner is associated with an active employee account, an inactive user account, or a terminated employee record. For example, the ownership validation manager 406 may determine that a dataset owner referenced in the usage analytics data repository 114 corresponds to an employee who left the organization several months earlier. The ownership validation manager 406 may therefore classify the dataset as an orphaned data asset.

In some implementations, the ownership validation manager 406 may also evaluate organizational hierarchy metadata stored within the metadata and ownership repository 116 to determine whether responsibility for a dataset has been reassigned to another team or supervisor.

The data locking manager 408 may be configured to implement protective governance controls for datasets that have been identified as candidates for lifecycle management. Before initiating deletion or archival actions, enterprise administrators may prefer to temporarily restrict access to datasets in order to verify that the datasets are truly inactive. The data locking manager 408 may therefore initiate data access restrictions by interfacing with storage platform access control systems. For example, the data locking manager 408 may communicate with a storage governance service to temporarily revoke write access permissions for a dataset directory while allowing read-only access during a validation period. Such lock operations may prevent new data from being written to the dataset while allowing administrators to confirm whether the dataset remains actively used. Records describing the locking operation may be stored within the lifecycle action log repository 120 of the data store 110 to maintain an auditable record of lifecycle enforcement actions.

The notification and workflow manager 410 may coordinate communication and approval workflows associated with lifecycle governance actions. In one example, the notification and workflow manager 410 may generate alerts or messages to notify responsible stakeholders that a dataset has been identified as a candidate for lifecycle management. For example, if the ownership validation manager 406 determines that a dataset owner has left the organization, the notification and workflow manager 410 may notify a designated team supervisor or platform administrator associated with the dataset directory.

Notifications may be transmitted through enterprise communication systems or may be presented through the DALM interface 108 operating on the user electronic computing device 106. The notification and workflow manager 410 may also coordinate approval workflows that require administrator review before lifecycle actions are executed. For example, an administrator reviewing a dashboard presented by the lifecycle insight dashboard 414 may approve a recommendation to delete inactive datasets associated with a particular directory.

The controlled deletion manager 412 may be configured to execute lifecycle enforcement actions associated with datasets that have satisfied lifecycle governance criteria. Rather than performing immediate deletion operations, the controlled deletion manager 412 may implement staged deletion workflows designed to reduce operational risk. In one example, the controlled deletion manager 412 may schedule datasets for deletion after a configurable observation period during which administrators may verify that the datasets are no longer required. During this observation period, the datasets may remain locked or placed within a quarantine directory to prevent further modification. Once the observation period expires and the deletion workflow is approved, the controlled deletion manager 412 may initiate deletion operations through the distributed storage platform. Records describing the deletion actions may be stored within the lifecycle action log repository 120 to provide an auditable record of data lifecycle enforcement.

In some examples, the controlled deletion manager 412 may determine whether one or more preconditions associated with a candidate dataset have been satisfied before initiating deletion. The preconditions may include confirmation from the lifecycle policy evaluator 402 that the candidate dataset satisfies one or more lifecycle criteria, confirmation from the ownership validation manager 406 that the dataset is associated with an inactive owner or other qualifying ownership condition, expiration of a configurable observation period, and confirmation that no override instruction, exception condition, or renewed access activity has been detected. In one example, the controlled deletion manager 412 may monitor the usage analytics data repository 114, the metadata and ownership repository 116, and the lifecycle policy repository 118 to determine whether the candidate dataset remains eligible for deletion. For example, if a dataset that had not been accessed for ninety days is accessed during the observation period, or if a supervisor submits an override request through the DALM interface 108, the controlled deletion manager 412 may suspend, cancel, or defer the deletion workflow.

In some examples, the controlled deletion manager 412 may initiate one or more deletion operations directed to one or more storage objects associated with the candidate dataset. The deletion operations may include deleting a file, deleting a directory, deleting a logical dataset reference, deleting associated metadata entries, deleting replicated file instances maintained within the distributed storage environment, or deleting one or more combinations thereof. In one example, the controlled deletion manager 412 may interact with the distributed storage platform to remove underlying file-system objects corresponding to the candidate dataset and may further update one or more metadata records associated with the removed dataset. For example, when a candidate dataset corresponds to a directory containing stale machine learning training files owned by a terminated employee, the controlled deletion manager 412 may remove the directory contents, remove associated file-system references, and thereby reclaim replicated storage capacity previously consumed by the stale files. In other examples, the controlled deletion manager 412 may implement an alternative enforcement outcome in place of permanent deletion, such as archiving the candidate dataset, moving the candidate dataset to a quarantine location, migrating the candidate dataset to a lower-cost storage tier, or extending the observation period. The controlled deletion manager 412 may record the outcome of the deletion workflow, including any completed deletion operations, canceled deletion operations, exceptions, archival actions, or tier migration actions, within the lifecycle action log repository 120 to maintain an auditable record of lifecycle enforcement.

In one example, the controlled deletion manager 412 may execute deletion workflows according to different governance modes. A first governance mode may allow deletion to proceed automatically when lifecycle conditions are satisfied and no exception is detected. A second governance mode may require approval from an administrator, supervisor, or data owner before deletion is performed. A third governance mode may require the data locking manager 408 to maintain a lock state for a defined interval while the notification and workflow manager 410 solicits confirmation from one or more responsible parties. In this manner, the controlled deletion manager 412 may support fully automated deletion, semi-automated deletion, or administrator-mediated deletion depending on the governance policy stored in the lifecycle policy repository 118.

The lifecycle insight dashboard 414 may generate visual representations of lifecycle analytics data to assist administrators in understanding storage usage patterns and identifying opportunities for lifecycle governance actions. The lifecycle insight dashboard 414 may retrieve aggregated lifecycle metrics from the usage analytics data repository 114 and ownership metadata from the metadata and ownership repository 116 in order to present insights through the DALM interface 108. For example, the lifecycle insight dashboard 414 may display metrics describing directories containing large volumes of unused files, datasets that have not been accessed within defined time intervals, or datasets owned by inactive users. In some cases, the lifecycle insight dashboard 414 may also present analytics describing the replicated storage footprint associated with inactive datasets, thereby allowing administrators to understand the infrastructure impact associated with unused data assets. Example dashboard visualizations generated by the lifecycle insight dashboard 414 are illustrated in FIG. 5 and FIG. 6.

FIG. 5 illustrates an example lifecycle insight dashboard 500 that may be presented to a user through the DALM interface 108 on the user electronic computing device 106. The lifecycle insight dashboard 500 may present analytics related to datasets that have not experienced recent access activity, which may be referred to as “missing usage” datasets. The lifecycle insight dashboard 500 may be generated by the governance and insight engine 212 based on lifecycle intelligence stored in the usage analytics data repository 114 and contextual metadata stored in the metadata and ownership repository 116 of the data store 110. The lifecycle insight dashboard 500 may therefore allow administrators, platform engineers, or data governance personnel to quickly identify inactive data assets that may be candidates for lifecycle management actions such as archival, locking, or deletion.

In one example, the lifecycle insight dashboard 500 may include a navigation panel 502 that allows a user to select between multiple lifecycle analytics views supported by the DALM platform 104. The navigation panel 502 may include selectable dashboard categories such as asset summaries, missing usage analytics, inactive ownership analytics, platform usage metrics, and administrative notes. The navigation panel 502 may therefore allow a user to switch between different lifecycle analysis perspectives generated by the governance and insight engine 212. In the example illustrated in FIG. 5, the “missing usage” option may be selected within the navigation panel 502, which may cause the DALM platform 104 to present lifecycle analytics associated with datasets that have not been accessed within a defined time interval.

The lifecycle insight dashboard 500 may also include a summary panel 504 that presents high-level lifecycle metrics associated with datasets identified as having missing or unavailable usage activity. The summary panel 504 may consolidate key indicators that allow administrators to quickly evaluate the scale of datasets lacking recent access telemetry. In one example, the summary panel 504 may display a file count indicator 506 representing the number of files created prior to a specified time threshold for which recent usage activity is unavailable or has not been observed within a defined observation window. The governance and insight engine 212 may generate this metric by analyzing lifecycle analytics records stored in the usage analytics data repository 114 that were derived from audit telemetry processed by the audit data processing engine 208 described in FIG. 3. By presenting the file count indicator 506 within the summary panel 504, the DALM platform 104 may provide administrators with an immediate understanding of the scale of datasets that may lack usage visibility within the distributed storage environment.

The summary panel 504 may also include a replicated storage metric indicator 508 representing the total replicated file size associated with the datasets identified as having missing usage information. Distributed storage environments often maintain multiple replicas of stored files across different storage nodes in order to ensure durability and fault tolerance. As a result, datasets that appear relatively small based on logical file size may occupy significantly larger amounts of physical storage due to replication policies implemented by the distributed storage platform. The governance and insight engine 212 may calculate the replicated storage footprint represented by the replicated storage metric indicator 508 using replication attributes derived during the attribute derivation stage 308 described in FIG. 3 and stored within the usage analytics data repository 114. In this manner, the summary panel 504 may allow administrators to evaluate not only the number of files associated with missing usage information but also the infrastructure impact associated with those files.

In some implementations, the file count indicator 506 and the replicated storage metric indicator 508 may be presented using circular visual indicators or similar graphical elements within the summary panel 504. For example, the file count indicator 506 may display the total number of files lacking usage information at the center of a circular graphic, while the replicated storage metric indicator 508 may display the aggregated replicated storage size associated with those files. Although circular visual indicators are illustrated in FIG. 5, other visualization formats may be implemented without departing from the scope of the DALM platform 104. For example, the summary panel 504 may present the same lifecycle metrics using numeric counters, bar graphs, gauge indicators, or tabular summaries depending on the user interface configuration implemented within the DALM interface 108.

The lifecycle insight dashboard 500 may also include a pie chart visualization 510 that categorizes inactive datasets according to file type. The governance and insight engine 212 may analyze lifecycle analytics records stored in the usage analytics data repository 114 and classify files into categories such as text files, backup files, temporary files, executable files, or other dataset types. The pie chart visualization 510 may therefore illustrate which categories of files contribute most significantly to inactive storage consumption. For example, the pie chart visualization 510 may reveal that a substantial portion of unused storage space originates from historical backup files generated by automated data pipelines.

The lifecycle insight dashboard 500 may also include a ownership analytics panel 512 that organizes inactive datasets according to enterprise organizational structure. In one example, the ownership analytics panel 512 may present inactive datasets grouped by director-level organizational roles within the enterprise. The governance and insight engine 212 may retrieve ownership metadata from the metadata and ownership repository 116 to map dataset owners to organizational reporting hierarchies. The panel 512 may therefore display fields including director name, number of unique dataset owners associated with that director's organization, total file count, total file size, and replicated file size associated with inactive datasets within the organizational unit. Such analytics may allow enterprise leadership to identify which business units or teams are responsible for the largest volumes of unused storage.

In addition, the lifecycle insight dashboard 500 may include a dataset activity analysis panel 514 that identifies datasets that have not been accessed within a defined time window, such as the previous three months. The dataset activity analysis panel 514 may display fields including director identifier, number of dataset owners, inode count, file size, and replicated file size associated with the datasets. The inode count may represent the number of file system objects associated with a dataset directory within the distributed storage platform. By presenting inactivity analytics at the director level, the dataset activity analysis panel 514 may allow administrators to identify specific organizational groups that may benefit from targeted lifecycle cleanup initiatives.

FIG. 6 illustrates another example lifecycle insight dashboard 600 that may be presented through the DALM interface 108 on the user electronic computing device 106. The lifecycle insight dashboard 600 may present lifecycle analytics associated with datasets that are owned by inactive users within the enterprise environment. The lifecycle insight dashboard 600 may be generated by the governance and insight engine 212 of the DALM platform 104 using lifecycle intelligence derived from audit telemetry processed by the audit data processing engine 208 and stored within the usage analytics data repository 114 and the metadata and ownership repository 116 of the data store 110. By presenting ownership-related lifecycle insights, the lifecycle insight dashboard 600 may allow administrators to identify orphaned data assets that may remain stored within the distributed storage environment even though the associated dataset owners are no longer active within the organization.

The lifecycle insight dashboard 600 may include the navigation panel 502 described in relation to FIG. 5. The navigation panel 502 may allow a user to select between different lifecycle analytics views generated by the DALM platform 104, such as asset analytics, missing usage analytics, inactive ownership analytics, platform usage analytics, and administrative notes. In the example illustrated in FIG. 6, the inactive ownership analytics option within the navigation panel 502 may be selected. When the inactive ownership option is selected, the governance and insight engine 212 may retrieve lifecycle intelligence associated with datasets whose owners are classified as inactive within enterprise identity records stored in the metadata and ownership repository 116.

The lifecycle insight dashboard 600 may further include a summary panel 602 that presents high-level lifecycle metrics associated with datasets owned by inactive users. The summary panel 602 may provide a quick visual overview of the scale and storage impact of orphaned data assets identified by the DALM platform 104. In one example, the summary panel 602 may include a first indicator 604 representing the total file count associated with datasets owned by inactive users. The governance and insight engine 212 may generate the file count indicator 604 by correlating dataset ownership metadata retrieved from the metadata and ownership repository 116 with lifecycle analytics stored in the usage analytics data repository 114.

The summary panel 602 may also include a second indicator 606 representing the total logical file size associated with datasets owned by inactive users. The governance and insight engine 212 may determine the file size values displayed within the second indicator 606 by aggregating dataset size information associated with lifecycle analytics records stored in the usage analytics data repository 114. The summary panel 602 may further include a third indicator 608 representing the replicated storage footprint associated with datasets owned by inactive users. The replicated storage footprint displayed in the third indicator 608 may be calculated using replication attributes derived during the attribute derivation stage 308 described in FIG. 3. Because distributed storage systems may replicate datasets across multiple storage nodes for reliability and fault tolerance, the replicated storage size displayed in the third indicator 608 may provide administrators with a more accurate representation of the infrastructure resources consumed by orphaned datasets.

In one example, the indicators 604, 606, and 608 may be presented as circular visual indicators positioned near the top of the lifecycle insight dashboard 600 to allow administrators to quickly evaluate the scale of inactive ownership datasets.

The lifecycle insight dashboard 600 may also include a data ownership distribution visualization 610 that presents aggregated analytics describing inactive dataset ownership patterns. The governance and insight engine 212 may generate the analytics presented within the data ownership distribution visualization 610 using ownership metadata retrieved from the metadata and ownership repository 116 in combination with lifecycle metrics derived from the usage analytics data repository 114. The data ownership distribution visualization 610 may include multiple graphical summaries illustrating different dimensions of inactive ownership analytics.

In one example, the data ownership distribution visualization 610 may include a first pie chart 612 illustrating file count distribution by inactive owner type. The governance and insight engine 212 may categorize dataset owners based on attributes such as account type, employment classification, or user role. For example, datasets may be associated with former employees, inactive contractor accounts, archived service accounts, or other user account categories maintained by enterprise identity management systems. The pie chart 612 may therefore display the proportion of inactive datasets associated with each owner type.

The data ownership distribution visualization 610 may also include a second pie chart 614 illustrating total file size distribution by inactive owner type. While the pie chart 612 may represent the number of files associated with different inactive ownership categories, the pie chart 614 may represent the corresponding logical storage footprint associated with those categories. The governance and insight engine 212 may calculate these file size metrics using dataset size attributes stored in the usage analytics data repository 114.

The data ownership distribution visualization 610 may further include a third pie chart 616 illustrating inactive owner files categorized by file type. The governance and insight engine 212 may classify files based on attributes derived during the attribute derivation stage 308 described in FIG. 3, such as file format or dataset classification. For example, the pie chart 616 may illustrate whether inactive datasets are primarily associated with archived backup files, temporary processing files, structured data files, or other dataset categories.

The lifecycle insight dashboard 600 may also include an inactive owner analytics table 618 that provides a drill-through view of datasets associated with inactive users. The inactive owner analytics table 618 may present detailed ownership metadata that allows administrators to identify specific datasets and user accounts associated with inactive ownership conditions. In one example, the inactive owner analytics table 618 may include columns describing director identifier, asset owner name, asset owner identifier, account type, and organizational reporting hierarchy information. The governance and insight engine 212 may generate this information using identity metadata stored in the metadata and ownership repository 116. By presenting hierarchical reporting information, the inactive owner analytics table 618 may allow administrators to determine which organizational leaders may be responsible for datasets associated with inactive users.

The lifecycle insight dashboard 600 may further include an inactive identifier analytics table 620 that presents datasets associated with inactive enterprise user identifiers. The inactive identifier analytics table 620 may present information similar to the inactive owner analytics table 618 but may focus on inactive enterprise identity identifiers associated with datasets stored within the distributed storage environment. In one example, the inactive identifier analytics table 620 may include fields such as director identifier, asset owner name, asset owner identifier, account type, and reporting hierarchy metadata derived from enterprise directory systems. The governance and insight engine 212 may generate the data displayed in the inactive identifier analytics table 620 by correlating lifecycle analytics records stored in the usage analytics data repository 114 with identity metadata retrieved from the metadata and ownership repository 116.

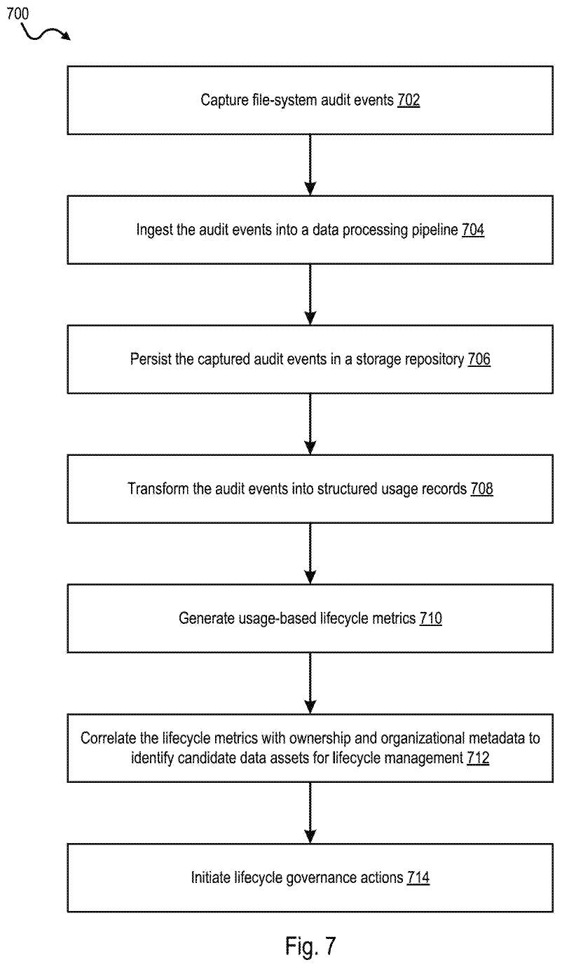

FIG. 7 illustrates an example method 700 that may be performed by the DALM system 100 to monitor data asset activity, generate lifecycle intelligence, and initiate lifecycle governance actions within a distributed storage environment. The operations illustrated in FIG. 7 may be implemented by one or more components of the DALM platform 104 executing on the server computing device 102. In one example, the operations of method 700 may convert low-level storage access telemetry generated by a distributed storage platform into actionable lifecycle governance decisions that may improve storage efficiency and reduce infrastructure impact associated with inactive or orphaned data assets.

At operation 702, the method 700 may include capturing storage access events associated with data assets stored within a distributed storage environment. The operation 702 may be performed by the audit log generator 202 described in relation to FIG. 2. The audit log generator 202 may monitor file-system activity occurring within the distributed storage platform and generate audit records describing operations performed on stored datasets. For example, the audit log generator 202 may record events such as file creation operations, read requests, write operations, directory listing requests, or file deletion operations. Each captured event may include contextual metadata such as the dataset path, the requesting user identifier, a timestamp associated with the access event, and infrastructure attributes such as the storage node or replication factor associated with the dataset. In one example, a data scientist executing a machine learning training job may read a dataset stored at “/analytics/customer-model/training-data.csv,” and the audit log generator 202 may generate an audit entry describing the access event.

At operation 704, the method 700 may include ingesting the captured audit events into the lifecycle intelligence processing pipeline of the DALM platform 104. The operation 704 may be performed by the audit event ingester 204 described in FIG. 2. The audit event ingester 204 may collect audit records generated by the audit log generator 202 and convert the records into structured event messages suitable for downstream processing. In some implementations, the audit event ingester 204 may monitor storage platform log streams and detect newly generated audit entries in near real time. The audit event ingester 204 may also implement reliability mechanisms such as message acknowledgment or retry logic to ensure that captured telemetry events are not lost during ingestion.

At operation 706, the method 700 may include transmitting the ingested audit events through a distributed event stream that enables scalable processing of the captured telemetry. This operation may be performed by the event streaming engine 206 described in relation to FIG. 2. The event streaming engine 206 may store the ingested event messages within an ordered event stream or distributed commit log that allows downstream processing components to consume the events asynchronously. In one example, the event streaming engine 206 may buffer and distribute audit events generated across multiple nodes within a distributed storage cluster so that the audit data processing engine 208 may process the events in parallel. The event streaming engine 206 may also maintain replayable event logs that allow the DALM platform 104 to reprocess historical telemetry data if additional analytics processing is required.

At operation 708, the method 700 may include transforming the captured audit telemetry into structured lifecycle intelligence that may support lifecycle analytics. This operation may be performed by the audit data processing engine 208 described in relation to FIGS. 2 and 3. The audit data processing engine 208 may perform multiple transformation stages, including log parsing 302, event filtering 304, normalization 306, attribute derivation 308, and usage aggregation 310. For example, the log parsing stage 302 may convert raw log entries into structured event records, the event filtering stage 304 may remove non-actionable system events, and the normalization stage 306 may standardize file paths and user identifiers across enterprise storage environments. The attribute derivation stage 308 may derive additional attributes such as dataset identifiers, ownership attributes, or replication characteristics associated with the dataset. Finally, the usage aggregation stage 310 may aggregate the processed event records into lifecycle metrics such as access frequency, last-access timestamps, or inactivity indicators.

At operation 710, the method 700 may include storing the generated lifecycle intelligence within a lifecycle analytics repository so that the lifecycle metrics may be accessed for governance analysis. This operation may be performed by the lifecycle analytics repository 210 in coordination with the usage analytics data repository 114 and the audit event data repository 112 within the data store 110. In one example, the audit data processing engine 208 may store processed lifecycle metrics within the usage analytics data repository 114, while parsed audit records may be preserved within the audit event data repository 112 to enable replayable processing of historical telemetry. The lifecycle analytics repository 210 may further enrich the lifecycle intelligence by retrieving contextual metadata from the metadata and ownership repository 116, including dataset ownership attributes, organizational hierarchy information, and user identity status.

At operation 712, the method 700 may include evaluating lifecycle intelligence to determine whether particular datasets satisfy lifecycle management criteria. This evaluation may be performed by the governance and insight engine 212 described in relation to FIG. 4. Several subcomponents of the governance and insight engine 212 may participate in the evaluation. For example, the lifecycle policy evaluator 402 may analyze lifecycle metrics stored in the usage analytics data repository 114 and determine whether a dataset satisfies lifecycle policies stored within the lifecycle policy repository 118. The dataset risk identifier 404 may analyze replication metadata derived by the attribute derivation stage 308 to determine the infrastructure impact associated with inactive datasets. The ownership validation manager 406 may retrieve ownership and identity metadata from the metadata and ownership repository 116 in order to determine whether a dataset is associated with an inactive user account, a terminated employee, or a reassigned organizational owner.

At operation 714, the method 700 may include initiating one or more lifecycle governance actions based on the evaluation of lifecycle intelligence. The governance and insight engine 212 may initiate several types of governance actions depending on the lifecycle conditions associated with a dataset as further described in relation to FIG. 4.

Once one or more datasets are identified as being stale or in need of deletion, the data locking manager 408 may temporarily restrict write access to a dataset that has been identified as inactive in order to confirm that the dataset is no longer actively used. The notification and workflow manager 410 may notify responsible administrators or organizational supervisors associated with the dataset and may coordinate approval workflows presented through the DALM interface 108. In some implementations, the controlled deletion manager 412 may initiate controlled deletion workflows associated with datasets that have satisfied lifecycle management criteria.

The lifecycle governance actions initiated at operation 714 may therefore represent an intelligent lifecycle enforcement process rather than a simplistic rule-based deletion mechanism. The governance and insight engine 212 may evaluate multiple sources of information when determining appropriate lifecycle actions, including historical access activity derived from audit telemetry, dataset ownership status obtained from identity systems, organizational hierarchy context retrieved from the metadata and ownership repository 116, and infrastructure impact metrics such as replicated storage footprint. As a result, a dataset may only be scheduled for deletion after the DALM platform 104 determines that the dataset has remained inactive for a defined period of time, is associated with an inactive owner or other qualifying lifecycle condition, and has passed a configurable observation and governance workflow process.

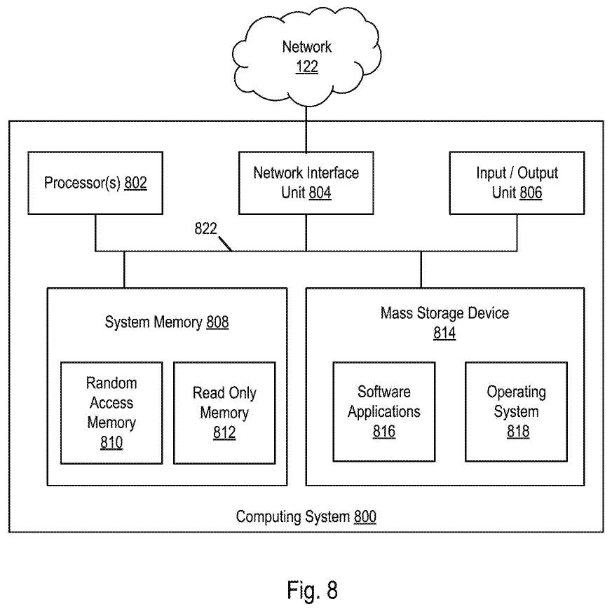

FIG. 8 illustrates an example block diagram of a virtual or physical computing system 800. One or more aspects of the computing system 800 can be used to implement the systems, platforms, and processes described herein.

In the embodiment shown, the computing system 800 includes one or more processors 802, a system memory 808, and a system bus 822 that couples the system memory 808 to the one or more processors 802. The system memory 808 includes RAM (Random Access Memory) 810 and ROM (Read-Only Memory) 812. A basic input/output system that contains the basic routines that help to transfer information between elements within the computing system 800, such as during startup, is stored in the ROM 812. The computing system 800 further includes a mass storage device 814. The mass storage device 814 is able to store instructions and data for one or more software applications 816. The one or more processors 802 can be one or more central processing units or other processors.

The mass storage device 814 is connected to the one or more processors 802 through a mass storage controller (not shown) connected to the system bus 822. The mass storage device 814 and its associated computer-readable data storage media provide non-volatile, non-transitory storage for the computing system 800. Although the description of computer-readable data storage media contained herein refers to a mass storage device, such as a hard disk or solid state disk, it should be appreciated by those skilled in the art that computer-readable data storage media can be any available non-transitory, physical device or article of manufacture from which the central display station can read data and/or instructions.

Computer-readable data storage media include volatile and non-volatile, removable and non-removable media implemented in any method or technology for storage of information such as computer-readable software instructions, data structures, program modules or other data. Example types of computer-readable data storage media include, but are not limited to, RAM, ROM, EPROM, EEPROM, flash memory or other solid state memory technology, CD-ROMs, DVD (Digital Versatile Discs), other optical storage media, magnetic cassettes, magnetic tape, magnetic disk storage or other magnetic storage devices, or any other medium which can be used to store the desired information and which can be accessed by the computing system 800.

According to various embodiments of the invention, the computing system 800 may operate in a networked environment using logical connections to remote network devices through the network 122. The network 122 is a computer network, such as an enterprise intranet and/or the Internet. The network 122 can include a LAN, a Wide Area Network (WAN), the Internet, wireless transmission mediums, wired transmission mediums, other networks, and combinations thereof. The computing system 800 may connect to the network 122 through a network interface unit 804 connected to the system bus 822. It should be appreciated that the network interface unit 804 may also be utilized to connect to other types of networks and remote computing systems. The computing system 800 also includes an input/output controller 806 for receiving and processing input from a number of other devices, including a touch user interface display screen, or another type of input device. Similarly, the input/output controller 806 may provide output to a touch user interface display screen or other type of output device.

As mentioned briefly above, the mass storage device 814 and the RAM 810 of the computing system 800 can store software instructions and data. The software instructions include an operating system 818 suitable for controlling the operation of the computing system 800. The mass storage device 814 and/or the RAM 810 also store software instructions, that when executed by the one or more processors 802, cause one or more of the systems, devices, or components described herein to provide functionality described herein. For example, the mass storage device 814 and/or the RAM 810 can store software instructions that, when executed by the one or more processors 802, cause the computing system 800 to receive and execute managing network access control and build system processes.

The disclosed computing system provides a physical environment with which aspects of the DALM system 100 described herein may be implemented. It is noted that the disclosure computing system may be used to implement various computing devices contemplated herein, such as one or more server computing devices used to provide associated services, data store servers storing item information, or end-user devices, such as a user computing system having a browser installed thereon, or a mobile device having either a browser or mobile application installed therein. It is in this environment that the forecasting processes described herein may be implemented.

While particular uses of the technology have been illustrated and discussed above, the disclosed technology can be used with a variety of data structures and processes in accordance with many examples of the technology. The above discussion is not meant to suggest that the disclosed technology is only suitable for implementation with the data structures shown and described above. For examples, while certain technologies described herein were primarily described in the context of content generation systems and pipelines, technologies disclosed herein are applicable to data and methods for determining display of items at a retail website generally.

This disclosure described some aspects of the present technology with reference to the accompanying drawings, in which only some of the possible aspects were shown. Other aspects can, however, be embodied in many different forms and should not be construed as limited to the aspects set forth herein. Rather, these aspects were provided so that this disclosure was thorough and complete and fully conveyed the scope of the possible aspects to those skilled in the art.

As should be appreciated, the various aspects (e.g., operations, memory arrangements, etc.) described with respect to the figures herein are not intended to limit the technology to the particular aspects described. Accordingly, additional configurations can be used to practice the technology herein and/or some aspects described can be excluded without departing from the methods and systems disclosed herein.

Similarly, where operations of a process are disclosed, those operations are described for purposes of illustrating the present technology and are not intended to limit the disclosure to a particular sequence of operations. For example, the operations can be performed in differing order, two or more operations can be performed concurrently, additional operations can be performed, and disclosed operations can be excluded without departing from the present disclosure. Further, each operation can be accomplished via one or more sub-operations. The disclosed processes can be repeated.

Although specific aspects were described herein, the scope of the technology is not limited to those specific aspects. One skilled in the art will recognize other aspects or improvements that are within the scope of the present technology. Therefore, the specific structure, acts, or media are disclosed only as illustrative aspects. The scope of the technology is defined by the following claims and any equivalents therein.

What is claimed is:

1. A system for managing data assets stored within a data storage environment, the system comprising:
one or more processors; and
a memory storing instructions that, when executed by the one or more processors, cause the system to:
capture telemetry associated with operations performed on one or more data assets stored within the data storage environment;
process the telemetry to generate lifecycle intelligence associated with the one or more data assets by transforming the telemetry into lifecycle analytics describing activity associated with the one or more data assets;
evaluate the lifecycle intelligence to determine whether the one or more data assets satisfy one or more lifecycle governance conditions; and
initiate, based on the evaluation of the lifecycle intelligence, one or more lifecycle governance actions associated with the one or more data assets, the lifecycle governance actions including executing a controlled deletion workflow to remove at least a portion of the one or more data assets from the data storage environment.

2. The system of claim 1, wherein the instructions further cause the system to process the telemetry by parsing audit log records generated by the data storage environment, filtering non-actionable system-generated events, normalizing dataset identifiers, and aggregating the processed telemetry into lifecycle analytics describing activity associated with the one or more data assets.

3. The system of claim 1, wherein the instructions further cause the system to correlate the lifecycle intelligence with ownership metadata obtained from an enterprise identity management system to determine an ownership status associated with the one or more data assets.

4. The system of claim 3, wherein the ownership status indicates that an owner associated with the one or more data assets corresponds to an inactive user account or a terminated employee account within the enterprise identity management system.

5. The system of claim 1, wherein the instructions further cause the system to execute the controlled deletion workflow by selecting the at least a portion of the one or more data assets for deletion based on a combination of:
(i) historical usage information derived from the telemetry associated with the one or more data assets,
(ii) ownership status associated with the one or more data assets, and
(iii) organizational hierarchy information associated with an owner of the one or more data assets.

6. The system of claim 5, wherein the historical usage information includes both a last access time and an access frequency associated with the one or more data assets during a defined observation period.

7. The system of claim 1, wherein the instructions further cause the system to automatically perform capturing, processing, and evaluating operations at periodic intervals to continuously monitor activity associated with data assets stored within the data storage environment.

8. The system of claim 1, wherein the lifecycle governance actions further include temporarily restricting write access to a dataset associated with the one or more data assets by placing the dataset in a locked state during a validation period prior to executing the controlled deletion workflow.

9. The system of claim 1, wherein the instructions further cause the system to generate lifecycle analytics visualizations for presentation on a graphical user interface dashboard, the visualizations summarizing activity patterns, ownership attributes, or storage utilization associated with the one or more data assets to facilitate administrative review of the lifecycle governance actions.

10. A computer-implemented method for managing data assets stored within a data storage environment, the method comprising:
capturing, by a computing system, telemetry associated with operations performed on one or more data assets stored within the data storage environment;
processing the telemetry to generate lifecycle intelligence associated with the one or more data assets by transforming the telemetry into lifecycle analytics describing activity associated with the one or more data assets;
evaluating the lifecycle intelligence to determine whether the one or more data assets satisfy one or more lifecycle governance conditions; and
initiating, based on the evaluation of the lifecycle intelligence, one or more lifecycle governance actions associated with the one or more data assets, the lifecycle governance actions including executing a controlled deletion workflow to remove at least a portion of the one or more data assets from the data storage environment.

11. The method of claim 10, wherein processing the telemetry further comprises parsing audit log records generated by the data storage environment, filtering non-actionable system-generated events, normalizing dataset identifiers, and aggregating the processed telemetry into lifecycle analytics describing activity associated with the one or more data assets.

12. The method of claim 10, further comprising correlating the lifecycle intelligence with ownership metadata obtained from an enterprise identity management system to determine an ownership status associated with the one or more data assets.

13. The method of claim 12, wherein the ownership status indicates that an owner associated with the one or more data assets corresponds to an inactive user account or a terminated employee account within the enterprise identity management system.

14. The method of claim 10, wherein executing the controlled deletion workflow comprises selecting the at least portion of the one or more data assets for deletion based on a combination of:
(i) historical usage information derived from the telemetry associated with the one or more data assets,
(ii) ownership status associated with the one or more data assets, and
(iii) organizational hierarchy information associated with an owner of the one or more data assets.

15. The method of claim 14, wherein the historical usage information includes both a last access time and an access frequency associated with the one or more data assets during a defined observation period.

16. The method of claim 10, further comprising automatically performing the capturing, the processing, and the evaluating operations at periodic intervals to continuously monitor activity associated with data assets stored within the data storage environment.

17. The method of claim 10, wherein initiating the one or more lifecycle governance actions further comprises temporarily restricting write access to a dataset associated with the one or more data assets by placing the dataset in a locked state during a validation period prior to executing the controlled deletion workflow.

18. The method of claim 10, further comprising generating lifecycle analytics visualizations for presentation on a graphical user interface dashboard, the visualizations summarizing activity patterns, ownership attributes, or storage utilization associated with the one or more data assets to facilitate administrative review of the lifecycle governance actions.

19. A system for managing data assets stored within a data storage environment, the system comprising:
one or more processors; and
a memory storing instructions that, when executed by the one or more processors, cause the system to:
capture telemetry associated with operations performed on one or more data assets stored within the data storage environment;
retrieve metadata associated with the one or more data assets;
process the telemetry and the metadata to generate lifecycle intelligence associated with the one or more data assets, the lifecycle intelligence including historical usage information derived from the telemetry;
determine, based on the metadata, an ownership status associated with the one or more data assets;
evaluate the lifecycle intelligence, including historical usage information derived from the telemetry, in combination with the ownership status to determine whether at least a portion of the one or more data assets satisfies one or more lifecycle governance conditions; and
execute a controlled deletion workflow to remove the at least the portion of the one or more data assets from the data storage environment in response to determining that the one or more lifecycle governance conditions are satisfied, the lifecycle governance conditions being based on the combination of the historical usage information and the ownership status.

20. The system of claim 19, wherein the lifecycle governance conditions include conditions indicating that the at least a portion of the one or more data assets has not been accessed within a defined observation period and is associated with the ownership status corresponding to an inactive user account or a terminated user account, and wherein satisfaction of the lifecycle governance conditions causes the system to execute the controlled deletion workflow for the at least a portion of the one or more data assets.
